(19) United States
(12) Patent Application Publication
(10) Pub. No.: US 2024/0019701 A1
(43) Pub. Date: Jan. 18, 2024

(54) COMPACT EYEGLASS-MOUNTED HEADS-UP DISPLAY

(71) Applicant: Andrew Cunningham, Somerville, MA (US)

(72) Inventor: Andrew Cunningham, Somerville, MA (US)

(21) Appl. No.: 18/351,074

(22) Filed: Jul. 12, 2023

Related U.S. Application Data
(60) Provisional application No. 63/388,507, filed on Jul. 12, 2022.

(51) Int. Cl. G02B 27/01; G02C 11/00

(52) U.S. Cl. CPC G02B 27/0172; G02C 11/10; G02B 2027/0178

(57) ABSTRACT

A compact eyeglass-mounted heads-up display includes eyeglasses having a frame with a first side, a second side, and a bridge in between. The first side has a first arm and houses a first lens. The second side has a second arm and houses a second lens. A mirror is affixed to the first lens and focuses an image onto the wearer's eye. An electronics enclosure is mounted to the first arm. The enclosure houses electronics and a projector connected to the electronics. The projector is aligned with the mirror and generates the image.

### CROSS-REFERENCE TO RELATED APPLICATION

This application claims the benefit of priority of U.S. provisional application No. 63/388,507, filed Jul. 12, 2022, the contents of which are herein incorporated by reference.

### BACKGROUND OF THE INVENTION

The present invention relates to a heads-up display and, more particularly, to a compact eyeglass-mounted heads-up display.

People performing sports or other activities often benefit from access to metrics regarding that activity. These metrics can include Global Positioning System (GPS) data for pace, heart rate, inertial information, text notifications, etc. A popular way to get this information is via a ‘smart watch’ or ‘sports watch’ on the user's wrist, but checking such a watch requires a multi-second gap in situational awareness while the user focuses on and reads the watch while in motion. This results in less frequent referencing of the metrics, poor user experience, and potentially dangerous distractions.

Other sunglass devices in this category use a bulky heads-up display with a flat mirror or prism which often needs to be mounted externally to the sunglasses, making them appear dimmer and more noticeable to other people. This enlarges the athlete's blind spot and is visually unappealing.

As can be seen, there is a need for an eyeglass mounted heads-up display that is not bulky, does not enlarge the athlete's blind spot, and is visually appealing.

### SUMMARY OF THE INVENTION

In one aspect of the present invention, a compact eyeglass-mounted heads-up display comprises eyeglasses having a frame with a first side, a second side, and a bridge therebetween, the first side having a first arm and housing a first lens, the second side having a second arm and housing a second lens; a mirror affixed to the first lens and configured to focus an image onto a wearer's eye; and an electronics enclosure mounted to the first arm, the electronics enclosure housing electronics and a projector electronically communicating with the electronics, the projector aligned with the mirror and operative to generate the image.

The heads-up display of the present disclosure is mounted internally in a smaller form factor more conducive to sunglasses. These sunglasses replace a sports watch and perform the same function.

The heads-up may provide metrics for sports and athletic activities but is not limited thereto. It may be used to provide similar metrics for other activities such as to employees in a warehouse, warfighters on a battlefield, as well as for instructions for mailmen, driving directions, walking directions, etc.

These and other features, aspects and advantages of the present invention will become better understood with reference to the following drawings, description, and claims.

### BRIEF DESCRIPTION OF THE DRAWINGS

FIG. 1 is a top perspective view of glasses with an integrated heads-up display according to an embodiment of the present invention;

FIG. 2 is a bottom perspective view thereof; and

FIG. 3 is a top plan view thereof.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As used herein, the term “projector” refers to an optical instrument for projecting an image upon a surface, where the surface disclosed herein is a mirror. Broadly, one embodiment of the present invention is a compact eyeglass-mounted heads-up display. The heads-up display may be mounted on the inside of the lens in a much smaller form factor.

A mirror may be affixed to the inside surface of the lens adjacent to the nose supports, positioned just within the user's peripheral vision, and at an orientation selected to display an image so that it can be seen by the user. The mirror may be adjustable in some cases, e.g., to accommodate different face shapes.

An enclosure contains electronics (e.g., at least one component selected from the group consisting of GPS, battery, microcontroller, sensors, user interface, etc.) and a projector and is mounted on an arm of the sunglasses on the same side as the lens having the mirror. The enclosure contains a projector component operative to project an image onto the mirror.

In some embodiments, the enclosure may be integrated into the sunglasses frame.

A counterweight, which may be a battery or other device, may be installed on the arm opposite the enclosure in some embodiments to balance weight.

The electronics within the enclosure may receive sensor information (such as GPS location, etc.) and may display it in the same manner as a sports or smart watch. The electronics then project the collected data or an image onto the concave mirror, which reflects and focuses the image directly into the user's eye. The mirror surface is positioned and configured at a focal length that appears far away from the user in a manner that prevents multiple ghost images from blurring the image.

The enclosure and mirror may be placed on the right side, the left side, or both. The mirror may be placed anywhere between the sunglass lens and the eye, but near the nose bridge works best. The heads-up display is not limited to sunglasses and may be installed on regular glasses or prescription sunglasses.

The glasses of the present subject matter may contain the same sensors and electronics as a sports watch (GPS, inertial measurement unit (IMU), etc.) and project the collected data onto a concave mirror located on the lens of the eyeglasses. This provides the user with a heads-up display that is always present in the corner of their eye and is easy to reference during activities. Having these metrics more accessible increases their utility, enhances the user experience, and helps the user to maintain situational awareness while referencing the metrics.

Speakers may be installed on one or both arms in some cases, e.g., to play music and to work in conjunction with the display.

In some embodiments, the sunglasses may include a strap or similar device to secure the device to the user's head.

To manufacture the heads-up display disclosed herein, the manufacturer may adjustably affix a first surface parabolic concave mirror (with a focal length of about 75 mm) to the inside of a lens on pair of sunglasses near the nose bridge, such that it is visible in the user's peripheral vision. The manufacture may fasten suitable electronics, including a projector, in a compact enclosure constructed to accommodate the components. An organic light-emitting diode (OLED) works best for the projector, and the image it produces should be mirrored horizontally. The electronics should have all the power systems, microelectronics and sensors needed to operate, and buttons and switches to allow the user to interface with it. The enclosure containing the projector and the electronics should be fastened to the arm of the sunglasses on the same side as the mirror. The projector should be as far forward as possible, facing the inside of the sunglasses. There should be no obstructions between the mirror and the projector.

To use the heads-up display, the user may turn on the device and place it on their head. If necessary, the mirror may be adjusted until the image focuses. The user may select a mode (such as running, biking, etc.). Once the electronics are properly configured, the user may view any metrics displayed by looking at the mirror. The image is easy to focus on and is always in the same location. The device may be charged when not in use.

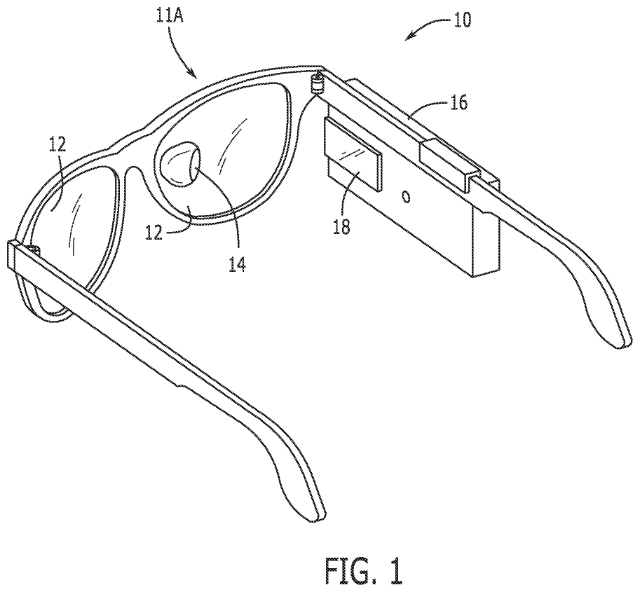

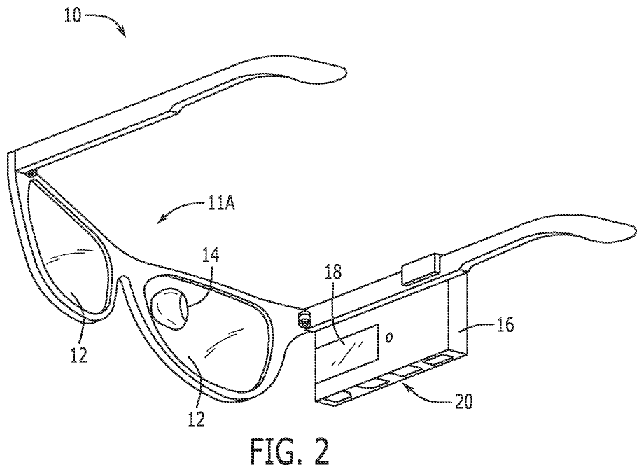

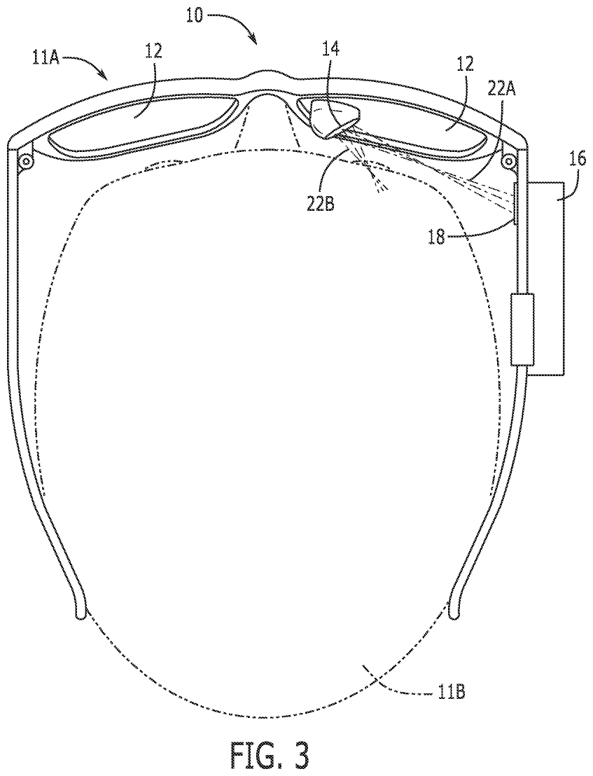

Referring to FIGS. 1 through 3, a glasses-integrated heads-up display 10 is illustrated. A pair of sunglasses 11A are shown with a parabolic mirror 14 mounted on a surface of one lens 12, facing the user and proximal to a position of the user's nose. An electronics enclosure 16 mounted on an arm of the sunglasses 11A corresponding to the lens 12 on which the mirror 14 is mounted. The enclosure 16 houses a projector 18 and electronics 20 (see FIG. 2). As shown in FIG. 3, projected images 22A from the projector 18 are reflected as images 22B directed toward the user's head 11B and more particularly, the user's eye (not shown).

It should be understood, of course, that the foregoing relates to exemplary embodiments of the invention and that modifications may be made without departing from the spirit and scope of the invention as set forth in the following claims.

What is claimed is:

1. A compact eyeglass-mounted heads-up display, comprising:
eyeglasses having a frame with a first side, a second side, and a bridge therebetween, the first side having a first arm and housing a first lens, the second side having a second arm and housing a second lens;
a mirror affixed to the first lens and configured to focus an image onto a wearer's eye; and
an electronics enclosure mounted to the first arm, the electronics enclosure housing electronics and a projector electronically communicating with the electronics, the projector aligned with the mirror and operative to generate the image.

2. The compact eyeglass-mounted heads-up display of claim 1, wherein the mirror is positioned proximal to the bridge.

3. The compact eyeglass—mounted heads-up display of claim 1, wherein the mirror is a concave parabolic mirror.

4. The compact eyeglass-mounted heads-up display of claim 1, wherein the projector comprises at least one organic light-emitting diode.

5. The compact eyeglass-mounted heads-up display of claim 1, wherein the projector projects a horizontally mirrored image.

6. The compact eyeglass-mounted heads-up display of claim 1, wherein a light path from the projector to the mirror is unobstructed when worn.

7. The compact eyeglass-mounted heads-up display of claim 1, wherein the mirror is adjustable to achieve a focused image.
